(19) United States
(12) Patent Application Publication
(10) Pub. No.: US 2006/0256733 A1
(43) Pub. Date: Nov. 16, 2006

(54) Methods and devices for discovering the topology of large multi-subnet LANs

(76) Inventor: Yigal Bejerano, Springfield, NJ (US)

Correspondence Address: HARNESS, DICKEY & PIERCE, P.L.C., P.O. BOX 8910, RESTON, VA, 20195, US

(21) Appl. No.: 11/127,082

(22) Filed: May 12, 2005

(51) Int. Cl. H04L 12/28; H04L 12/56

(52) U.S. Cl. 370/254; 370/400

(57) ABSTRACT

The physical topology of large, heterogeneous Ethernet LANs that may include multiple subnets may be discovered utilizing Management Information Base (MIB) information. Topology discovery tools and network management systems are introduced to carry out the topological discovery methods, features and functions of the present invention.

### BACKGROUND OF THE INVENTION

So-called enterprise networks are typically large and complex systems comprising hundreds or thousands of network elements (e.g., switches) from different vendors. Their complexity poses a challenge to network administrators who must ensure that such networks are managed effectively. To this end, maintaining an accurate and complete knowledge of a network's physical topology is a prerequisite to carrying out many critical network management tasks, including network diagnostics, resource management, event correlation, root cause analysis and server placement.

Such knowledge necessarily includes knowledge of the actual physical connections between network elements in a network, connections that are frequently changing. Because these changes occur so often, maintaining an accurate description of a network's topology is very difficult without the aid of automatic topology discovery tools.

It is difficult to obtain topological information. Consequently, the majority of commercially available network-management tools, such as Hewlett Packard's OpenView (www.openview.hp.com) and IBM's Tlvoli (www.tivoti.com), are only capable of providing network layer connectivity (i.e., at ISO layer-3 also referred to as the LP layer). These tools maintain router-to-router interconnections and router interface-to-subnet relationships only. Inferring a network layer topology is relatively easy because routers are aware of their immediate layer-3 neighbors as well as attached subnets. This information is also published in their associated SNMP Management Information Base (MIB). Though this information is sufficient to determine a layer-3 topology, it fails to capture the complex interconnections making up a Ethernet Local Area Network (LAN); the interconnections and subnets that underlie and make up the logical links of layer-3. So-called layer-3 interconnections elements, e.g. “bridges” and “switches”, unfortunately do not provide similar information, such as their immediate layer-2 neighbors. This complicates the discovery of the underlying physical topology of a network that is made up of multiple subnets.

Accordingly, it is desirable to provide for methods and devices that make it possible to discover the topology of large, multi-subnet LANs.

### SUMMARY OF THE INVENTION, WITH EXAMPLES

We have recognized that the topology of large, heterogeneous Ethernet LANs that comprise multiple subnets as well as “dumb” or uncooperative elements, may be discovered by relying on MIB information. Unlike other existing solutions that require high computational complexity, the methods and devices of the present invention provide for simple, efficient and practical mechanisms for discovering a network's physical topology with a very high probability.

In one embodiment of the present invention, a novel method determines the topology of a multi-subnet, heterogeneous network by first forming a preliminary topology based on address forwarding table (AFT) information obtained from one or more network elements (NEs) through Simple Network Management Protocol (SNMP) queries and then identifying one or more NEs that do not respond to SNMP queries and NEs adjacent to the identified NEs. The identified NEs are thereafter used to form a final topology.

An alternative method determines the topology of a multi-subnet heterogeneous network by: determining one or more connecting trees representing nodes in a subnet using AFT information; forming skeleton-trees representing the connecting trees; and iteratively merging one or more pairs of skeleton trees, each tree associated with a common anchor node, to obtain a complete topology.

Each of these methods may be carried out by a Network Management Station (NMS) or the like.

Simulations carried out by the present inventors demonstrate that the present invention, indeed, does discover the topology of LANs where existing techniques fail to do so.

### BRIEF DESCRIPTION OF THE EXEMPLARY DRAWINGS

FIG. 1(a) depicts an example of a network that includes subnets according to an embodiment of the present invention.

FIGS. 1(b)-1(d) depict connecting trees associated with subnets depicted in FIG. 1(a).

FIG. 2(a) depicts a connecting tree of a subnet method according to an embodiment of the present invention.

FIG. 2(b) depicts a skeleton-tree associated with the connecting tree in FIG. 2(a).

FIG. 3 depicts a series of diagrams illustrating steps in a topology discovery method used to generate skeleton-trees according to an embodiment of the present invention.

FIG. 4 depicts illustrative steps in a skeleton-tree creation technique according to embodiments of the present invention.

FIG. 5 depicts steps in a method for extending information in an AFT according to an embodiment of the present invention.

FIG. 6 depicts a summary of some of the steps in a topology discovery method according to an embodiment of the present invention.

FIGS. 7-12 depict graphs representing the results of some simulations carried out using exemplary methods and devices of the present invention.

### DETAILED DESCRIPTION OF THE INVENTION, INCLUDING EXAMPLES

Before presenting the details of the present invention, we first present some background information. In particular, we first introduce terminology familiar to those skilled in the art.

The domain over which a network's topology is to be discovered is known as a switched domain. This domain comprises a maximal set. V, of network elements, e.g., switches, hosts and routers, such that there is a path between every pair of elements involving only elements in V. Switches are actually hardware bridges so the terms “switch” and “bridge” may be used interchangeably, herein. However, we may often use the word “switch” to describe both. Although the switched domain may have an arbitrary topology, it may be assumed that each switch executes a known spanning tree protocol to determine its active ports. As a result, the active forwarding paths between domain elements yields a tree topology within the switched domain. This topology is the target of the present invention's topology discovery techniques.

In such a tree topology, switches are represented as internal nodes while hosts and routers are represented as leaf nodes. Because the latter are practically indistinguishable in a layer-2 topological discovery method, both hosts and routers may be referred to as hosts. From a layer-2 perspective, each router port that is connected to a switching domain is considered as a separate host. Thus, for purposes of the present invention, a single router may comprise several hosts; one host for each port connected to a switching domain that is to be “explored” (i.e., made a part of a discovered topology).

Packets may be forwarded only along links of a spanning tree. Their routes may be determined based on AFT information obtained through so-called backward learning, i.e., AFT information of a given active port comprises MAC addresses that are seen as source addresses on packets received by the port.

In a model that may be utilized by the present invention, a spanning tree embedded in a switched domain is modeled as an undirected tree, G(V, E). Such a tree may be referred to as a network. In this type of tree each node in V represents a network element and each edge in E represents a physical connection between two ports of active elements. The set V comprises both labeled and unlabeled nodes. By labeled nodes is meant those elements that have a unique identifying MAC address and can provide AFT information through SNMP queries. Unlabeled nodes, on the other hand, represent both “dumb” hub devices or switching elements with no SNMP support.

Thus, it may be said that AFT information can only be obtained from labeled nodes. To simplify the discussion which follows, labeled and unlabeled nodes may be referred to simply as switches and hubs, respectively.

Because G is a tree, there is a single path in G between every pair of nodes s, tεV, denoted by P_{s,t}. For every node νεV, we denote by D, its set of active ports. We use the notation (ν, k) to identify the k^{th} port of node νεV, and F_{ν,k} to denote the set of AFT entries at port (ν, k). To simplify our notation, parentheses and commas are often omitted from port-id notation when referring to a specific port of a node ν, e.g., ν1, ν2 and so on. We also denote by ν(u) a port of node ν that leads to node u in G, i.e., node uεF_{ν,ν(u)}.

Every labeled node in a network G is associated with one or more subnets. A subnet may be a maximal set of network elements N⊂V such that any two elements in N can communicate directly with each other without involving a router. Communication across different subnets, however, must usually go through a router. Thus, a packet from node s to node t in the same subnet N may only traverse along the path P_{s,t} in G. Typically, the association of a node is determined by its IP address and a corresponding network mask. For example, IP address 145.112.47.10 along with mask 255.255.255.0 identifies a subnet of network elements with IP addresses of the form 145.112.47.x, were x is any integer between 1 and 254. If Nis designated as the collection of subnets of the graph G, it can be said that every subnet (or any set of elements) NεNdefines a connecting tree in G, denoted by T^{N}(V^{N},E^{N}), which is a tree subgraph of G spanned by the nodes in subnet N that contains all nodes V^{N} and edges E^{N} of G that lie on paths between any pair of nodes in N. It should be noted that V^{N} does not explicitly represent hubs (unlabeled nodes). Hubs with degree 2 in a connecting tree T^{N} are omitted.

### EXAMPLE 1

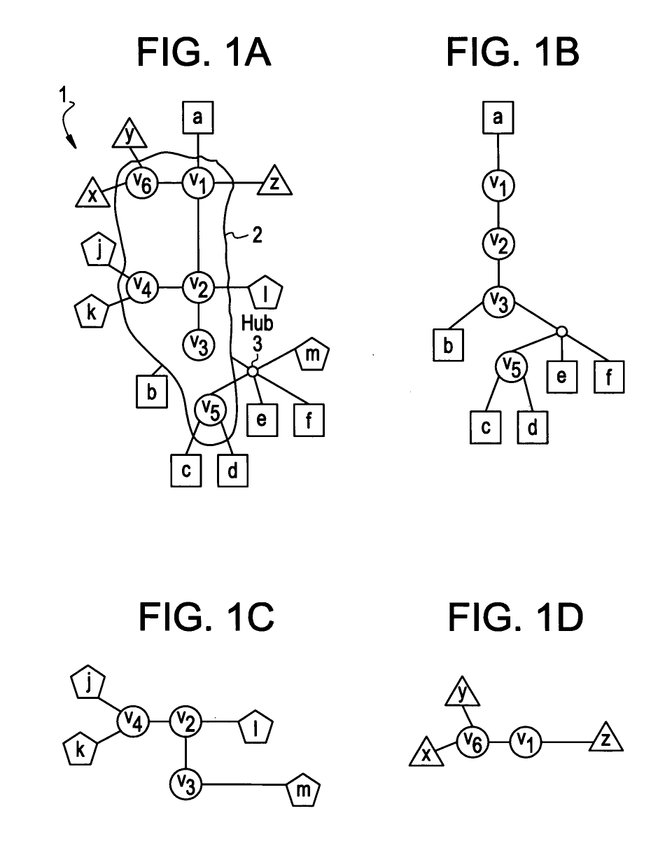

FIG. 1(a) depicts an example of a network 1 with switches 2 labeled V₁-V₆, one hub 3 and hosts labeled a-f, j-m, and x-z. The hosts are divided into three disjoint subnets; N₁={a,b,c,d,e,f}, N₂={j,k,l,m} and N₃={x,y,z}, where each switch is solely included in a separate subnet. The connecting trees of N₁, N₂ and N₃ are presented in FIGS. 1(b)-(d), respectively.

Let N_{ν}⊂Ndenote the collection of subnets containing node νεV in their connecting trees. (Recall that a switch may serve hosts in different subnets.) Essentially, AFTs of ports of a given node ν contain node-reachability information, mainly, for the subnets in N_{ν}. The AFTs of node ν may also contain the MAC addresses of other nodes as well. However, these AFTs entries are usually created from sporadic broadcast messages. Due to the aging process of AFT information, they are gradually removed from AFTs. Thus, in accordance with one embodiment of the present invention, the only AFT information utilized is that of the subnets in Nᵥ, for every node ν. Such subnet N is easy to identify by checking if hosts of N are included in AFTs of two or more ports of node ν.

The notation F_{v,k}^{N} will be used to denote all of the AFT entries of nodes in NεN_{ν} that are included in the AFT F_{ν,k} of ν. In addition, Dᵥ^{N} will be used to denote a set of active ports in T^{N}, i.e., kεDᵥ^{N} if F_{v,k}^{N}≠∅. It can be said that the AFT F_{v,k}^{N} of ν is complete for subnet N if F_{ν,k} contains the MAC addresses of all nodes in N that are reachable by port (ν,k). Moreover, AFT F_{ν,k} of ν is referred to as complete if it is completed for all the subnets NεN_{ν}.

In accordance with the present invention, it may be assumed that AFT information is complete for every node v. This requirement may also be relaxed in alternative embodiments of the present invention.

Table I lists the key notations used throughout the discussion above and below with a brief description of each.

TABLE 1

| Symbol | Semantics |
|---|---|
| G = (V, E) | Switched-domain network graph (tree) |
| (ν, k) | k^{th} port of node ν ∈ V(ν1, ν2, . . . ) |
| F_{ν,k} | AFT entries at (ν, k) (i.e., nodes reachable from) |
| D_{ν} | The set of active ports of node ν |
| V(u) | Port of node ν leading to node u in G |
| N | The subnets included in the switched domain |
| N_{ν} | Subnets in G containing ν in their spanning tree |
| P_{s,t} | The set of nodes along the path from s to t in G |
| T^{N}(V^{N}, E^{N}) | The connecting tree of the set (subnet) N |
| N | The set of nodes (subnets) that induce T^{N}(V^{N}, E^{N}) |
| V^{N} | All the network elements in T^{N} (the set N and the other |
| | switching elements in T^{N} |
| E^{N} | All the links included in T^{N} |
| F_{ν,k}^{N} | The AFT entries at (ν, k) of the nodes in N |
| D_{ν}^{N} | The set of active ports of node ν in the tree T^{N} |
| r | The root of a connecting tree T^{N} |
| B_{ν} | The set of nodes (e.g., network elements)from N that are |
| | included in the subtree T^{N} rooted by ν |
| n_{ν} | The number assigned to node ν∈ V^{N} |
| X | The anchor nodes of the tree T^{N} |
| H(Y, A) | The skeleton-tree of the connecting tree T^{N} |
| C_{y} | The nodes in V^{N} represented by the vertex y∈ Y |

Having introduced some terminology, we now turn to a discussion of the present invention itself.

Initially, we introduce a general overview of the inventive methods and devices followed by a more detailed discussion.

One goal of the present invention is to discover the physical topology of an underlying multi-subnet network represented by the graph G(V,E) as accurately as possible. In accordance with the present invention, an NMS may comprise one or more appropriately programmed devices and/or controllers, such as microprocessors and the like that may include one or more programs to carry out the methods, functions and features of the present invention.

In one embodiment of the present invention, these programs may execute novel methods, processes and/or techniques (e.g., algorithms) which use AFT information from labeled nodes in G to: (1) discover the direct, physical connections between the active ports of a labeled element; and (2) identify the existence of unlabeled nodes, i.e., hubs, in G as well as the set of adjacent elements. As mentioned briefly before, in one embodiment of the present invention, discovering the physical topology of an underlying multi-subnet network may include two stages. First, a preliminary topology consisting of the connecting-tree T^{N} of every subnet NεNis determined by using AFT information of one or more nodes (e.g., network elements) in T^{N}. Because this information may be insufficient for determining a final or complete topology of T^{N}, the present invention further utilizes an auxiliary data structure, referred to as a skeleton-tree, to further discover the topology within a certain degree of accuracy during a second stage.

For example, some nodes or network elements may not respond to an SNMP query. In such an instance, the present invention may provide for identifying such network elements and adding one or more of the identified network elements (and adjacent network elements) to the preliminary topology using skeleton trees. After calculating subnet skeleton-trees, the present invention provides for iteratively merging one or more of these trees together. The merge operation continues until a final or complete topology of the network is obtained.

Such a merge operation may involve merging the identified network elements (and associated edge connectors) from subnets that share a network element in common to help form the final topology.

Before going further, it may be helpful to the reader if we first present one definition of a skeleton-tree data structure that may be utilized by the present invention.

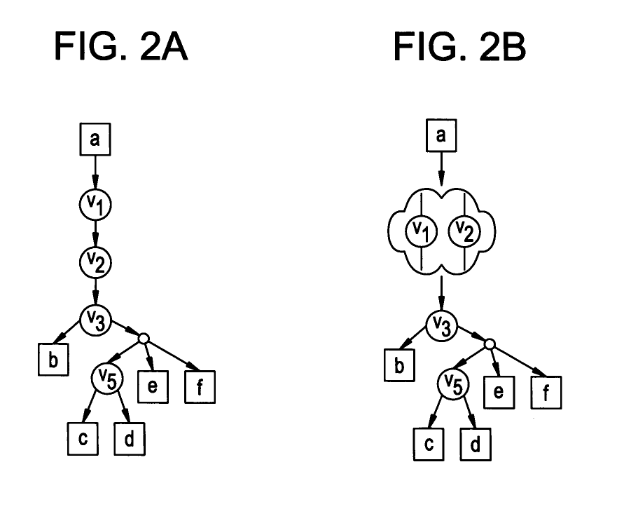

Consider a connecting-tree T^{N}(V^{N},E^{N}) of subnet NεNand, for now, assume complete AFT information. Two types of switches in T^{N} may be distinguished; junction nodes with degree 3 or more and transit nodes with degree 2 in T^{N}. The latter can be divided into successive segments, each one between two junctions, or a junction and a leaf node. For instance, consider the connecting tree of subnet N₁, depicted in FIG. 2(a). Here, ν₁ and ν₂ are transit nodes, while nodes ν₃ and ν₅ are junctions.

In accordance with the present invention, the skeleton-tree of a connecting-tree T^{N}, is defined by a graph H(Y,A) with a tree topology, where each vertex yεY represents a set of nodes C_{y}⊂V^{N} (C_{y} may be empty) and the arcs A represent tree links. Each node νεV^{N} is included in exactly one set C_{y}, yεY. Each leaf or junction node in T^{N} is exclusively represented by a single vertex yεY and a segment of transit nodes is represented by one or more vertices in Y. Moreover, the topology of T^{N} is obtained by replacing each vertex yε Y by the corresponding node or segment of nodes represented by the set C_{y}.

For the sake of clarity, T^{N} will be used to denote the elements of a connecting tree, while the notation H(Y,A) will be used to denote a skeleton-tree corresponding to the connecting tree. In one embodiment of the present invention, such a skeleton-tree may be stored as a data structure.

Because a connecting tree T^{N} is part of an explored network, it is acceptable to use the terms nodes and links to denote its network elements and their interconnection, respectively. It should also be noted that the notation H(Y,A) may be viewed as a graphical representation of information that is acquired from the topology of a given skeleton-tree; its elements are termed vertices and arcs.

From a graph theory perspective, the graphs T^{N} and H(Y,A) may be referred to by those skilled in the art as homeomorphic. In other words, the topology of T^{N} may be obtained from the graph H by subdividing edges, until all the transit nodes are represented. Similarly, the graph H may be obtained from T^{N} by smoothing away the corresponding transit nodes. Consequently, it may be seen that there is a unique mapping from each node εε V^{N} to a single vertex yε Y. However, a reverse mapping is not always unique. When there is a unique mapping from a vertex yεY to a single node (network element) in T^{N}, then they both may be called anchors.

### EXAMPLE 2

FIG. 2(a) depicts the connecting tree of subnet N₁ while FIG. 2(b) depicts a corresponding skeleton-tree. It should be noted that FIG. 2(a) depicts a directed connecting tree rooted at node a. In some of the discussion which follows, such a tree may be used to illustrate a skeleton-tree creation step of the present invention. In addition, it may be seen that the skeleton tree of subnet N₁ represents switches {ν₁, ν₂} having a single vertex.

We now introduce the details of a TD technique that may be used by an NMS to infer the topology of a given LAN in accordance with an embodiment of the present invention.

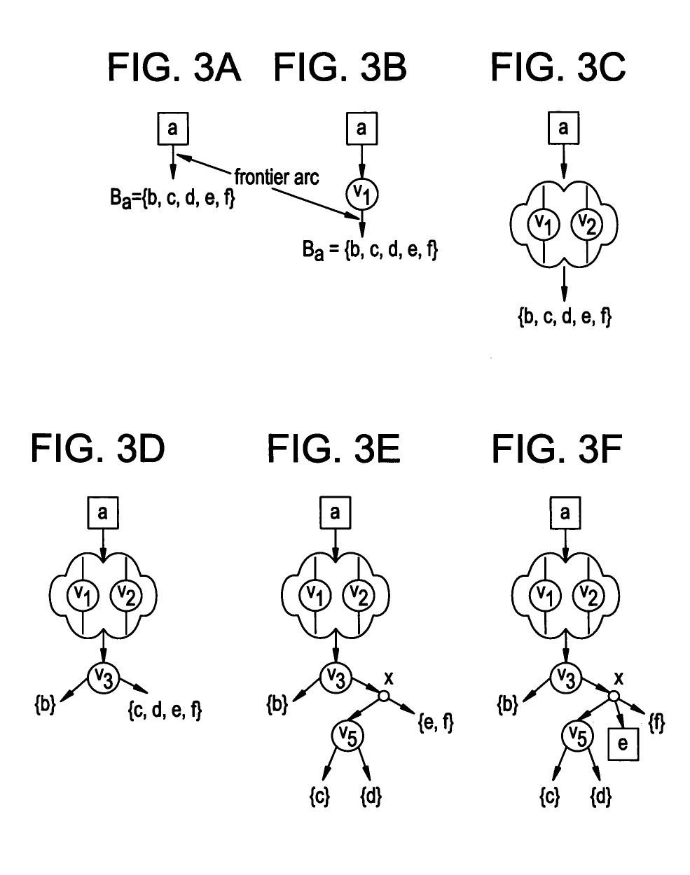

The set of subnets of a considered network may be denoted T^{N}^{ᵢ} (V^{N}^{ᵢ}, E^{N}^{ᵢ}), by N, and the connecting tree of every subnet NEN. In an embodiment of the present invention, an NMS or the like is operable to collect the required AFT information and then execute a topology discovery (TD) algorithm. The latter utilizes a skeleton-tree creation (STC) algorithm described in more detail below as a basic building block to first compute a skeleton-tree for every subnet Nᵢ and, then, to iteratively merge pairs of skeleton-trees until a complete network topology is obtained. A diagram of some of the steps involved in a TD technique according to one embodiment of the invention is shown in FIG. 3.

In accordance with one embodiment of the present invention, AFT information is obtained through backward learning on active ports. In other words, the AFT information of a given port comprises those MAC addresses where each MAC address may be viewed as representing a source address of packets received by a port. Thus, to collect all the required AFT information, the TD technique may need to populate the AFTs of a switch with the appropriate MAC addresses. More specifically, in one embodiment of the present invention for each subnet Nᵢ and its connected tree T^{N}^{ᵢ}, the TD technique may need to identify a root node rᵢεNᵢ and to guarantee that all of the AFTs of nodes in V^{N}^{ᵢ} satisfy the property:
Property 1: for every node vεV^{N}^{ᵢ}, the AFT port ν(rᵢ) contains rᵢ and the AFT of every other port is complete for the set Nᵢ.
   In accordance with one aspect of the present invention, we now show that this goal can be obtained by an AFT populating process described below.

For each subnet NᵢεN, an NMS or the like is operable to identify a root node rᵢ. If the NMS itself is included in the subnet Nᵢ, then the NMS itself serves as the root node rᵢ. Otherwise, every message from the NMS to any node vεNᵢ traverses through a router that is part of the connecting tree T^{N}^{ᵢ}. According to a known IP forwarding method, the route of an IP message may be determined according to its destination network. Consequently, all of the messages from an NMS to every node in Nᵢ traverse through a common router that can be identified, e.g., by using a traceroute. This router may be used as the root rᵢ of a considered connecting tree T^{N}^{ᵢ}. In both cases, any message from the NMS to a node vεNᵢ traverses along the path Pᵣ_{ᵢ}_{,v} between them and a reply is forwarded along the reverse path, which populates AFTs along this path accordingly. As a result, the NMS may only need to send a ping (i.e., sending ICMP ECHO REQUEST messages and receiving ICMP ECHO REPLY messages; if these messages are not supported in the considered network, trivial SNMP query messages can be used) message to every node in Nᵢ to populate the AFTs. This is enough to satisfy Property 1. In sum, an NMS may be operable to first populate one or more AFTs using a common router and then collect AFT information using standard SNMP queries. From the discussion above, the following Theorem follows.

Theorem 1: For every subnet Nᵢ, its connecting tree T^{N}^{ᵢ}(V^{N}^{ᵢ},E^{N}^{ᵢ}) and a root node rᵢεNᵢ (as determined above), the AFT populating process ensures that the AFTs of every node vεV^{N}^{ᵢ} satisfy the requirements of Property 1 set forth above.

After AFT information is collected, the present invention infers the topology of the network. In an embodiment of the present invention, this requires that an NMS be operable to calculate a skeleton tree for each subnet NᵢεNby invoking an STC algorithm (discussed below) using the following parameters: (1) the nodes of the considered subnet, Nᵢ; (2) the root, rᵢ, of the connecting tree as discussed above; (3) the set of nodes, V^{N}^{ᵢ}, of the connecting tree (this set comprises the nodes of Nᵢ and any node cεV that has at least two ports with AFT entries of nodes in Nᵢ); (4) the collected AFT information.

In further embodiments of the present invention, the NMS executes a routine to augment or “extend” the AFTs with an anchor node or set Xᵢ of every connecting tree T^{N}^{ᵢ}. Thereafter, the NMS is operable to merge pairs of skeleton-trees until a single skeleton-tree is obtained or the trees cannot be merged any more.

Consider two skeleton-trees Hⱼ(Yⱼ,Aⱼ) and Hⱼ(Yⱼ,Aj) of two different node sets Nᵢ and Nⱼ, and let Xᵢ and Xⱼ be their anchor sets, respectively. An NMS in accordance with the present invention may merge skeleton-trees if they have a common anchor node, which is a node rεXᵢ∩Xⱼ. A skeleton tree that results from this operation represents a connecting tree span of the set N=Nᵢ∩Nⱼ. After detecting two skeleton trees with common anchors, the NMS is operable to carry out further merges using the STC algorithm (discussed later) using the following parameters: (1) the node set N=Nᵢ∩Nⱼ; (2) a common anchor node rεXᵢ∩Xⱼ as a root node; (3) a set of nodes V^{N}=V^{N}^{₁}∩V^{N}^{₂} that comprises all nodes of a connecting tree T^{N}; and (4) AFT information augmented with two anchor sets Xᵢ and Xⱼ. Each iterative merge operation creates a new merged tree. Thereafter, the merged trees can themselves be further merged.

For example, in a further embodiment of the present invention, after a merge operation, an NMS may be further operable to further augment AFTs by identifying an anchor set node common to new (merged) skeleton trees. The merging continues until no common anchors can be identified.

### EXAMPLE 3

Consider three skeleton trees spanned by the subnets N₁, N₂ and N₃. The skeleton trees of subnets N₁ and N₂ can be merged by an NMS using node ν₃ as a common anchor. Consequently, nodes ν₁ and ν₂ appear as anchor nodes in a resulting skeleton-tree. Then, an NMS may merge the skeleton tree of both subnets, T^{N}^{₁}^{∩N}^{₂}, with the skeleton tree of subnet N₃, where node ν₁ is used as a common anchor. This merge operation yields an overall network topology.

Throughout our discussion above, we have made reference to a skeleton-tree creation (STC) technique or algorithm (i.e., method). This is a building block of the present invention.

In accordance with embodiments of the present invention, STC algorithms are based on properties of a connecting tree T^{N}(V^{N}, E^{N}). First, a root-node rεN is selected for the connecting tree T^{N}. It should be noted that the node r may be any node in N and may be completely independent of a root node used by a known spanning tree algorithm. For each node νεV^{N} let B_{ν}⊂N denote the set of nodes from N in the subtree rooted by ν and let |B_{ν}| be its size. As described in more detail below, the sets B_{ν},εV^{N}, can be calculated by an NMS from AFT information. Such sets also have the following property:
Property 2: for every pair of nodes ν,uεV^{N}, such that u is a descendent (node u is included in the subtree rooted by node ν) of ν, it follows that Bᵥ subsumes the set Bᵤ, i.e., B_{ν}⊃Bᵤ.

In particular, if ν is a junction node or νεN then the set Bᵤ is explicitly a subset of B_{ν}, i.e., B_{ν}⊃Bᵤ. This observation is used by an NMS to compile a list L of nodes in V^{N}-r sorted in an order according to their |B_{ν}| values. This list defines an ordered relationship between anchor nodes of a tree where, for example, each junction node and every node in N appears in L before each one of its descendent, and after its ancestor, anchor nodes. Thereafter, an NMS may be further operable to conduct a top-down discovery of a corresponding (skeleton) tree topology.

To summarize so far, in embodiments of the present invention an NMS or the like is operable to: (i) first determine one or more connecting trees representing nodes in a subnet using AFT information; and (ii) initially use an STC algorithm to form a skeleton tree representing each subnet.

The NMS may thereafter also be operable to use an STC method to carry out merge operations using one or more pairs of skeleton trees that share a common anchor node to obtain a complete topology.

What follows is a more detailed description of some of the STC methods provided by the present invention. First, we present several basic properties that form the foundation of the inventive methods.

In the following, consider a set of nodes N (that may be one or more subnets) and let T^{N}(V^{N},E^{N}) be a connecting tree spanned by this set, N, rooted by a node rεN. Initially, assume that the AFTs of all of the nodes νε V^{N} are complete for the set N. (Later this requirement will be relaxed in alternative embodiments of the present invention.)

For each node νεV^{N}, we may refer to a port ν(r) that leads to a root as a “root-port” and to all its other active ports, Dᵥ^{N}−v(r), as “leaf-ports.” We may define the set B_{ν}⊂N of all the nodes of N that are included in the subtree (this subtree may be obtained by removing the root-port of ν) of T^{N} rooted by node ν and denote the size of this set as |B_{ν}|. The set B_{ν} may be calculated from the AFTs as follows; Bᵥ=∩_{kεD}_{ᵥ}_{-{v(r)}}F_{v,k}^{N}; we add node ν to B_{ν} if νε N. Note that it may also be calculated by Bᵥ=N−F_{v,v(r)}^{N}. The sets {B_{ν}} have the following properties.

Property A: For every node vεV^{N}, Bᵥ≠∅.

Property B: For every node ν and any descendent u of node ν follows that Bᵥ⊃Bᵤ and |Bᵥ|≧|Bᵤ|.

Property C: For every node vεN and any one of its descendent uεV^{N} follows that Bᵥ⊃Bᵤ and |Bᵥ|≧|Bᵤ|.

Property D: For every junction node vεV^{N} and any of its descendent uεV^{N}, Bᵥ⊃Bᵤ and |Bᵥ|≧|Bᵤ|.

Proofs of Properties A-D have been developed by the present inventors. These proofs have been omitted in order to make it easier on the reader. Such proofs are also not necessary for an understanding of the present invention.

These properties enable the establishment of an ordered relationship between nodes. In a further embodiment of the present invention, an NMS may be operable to assign a value n_{ν} to each node νεV^{N} as defined by Equation 1 below:

$${n}_{v} = \{ \begin{matrix}\vert N \vert + 1 / 2 & If v = r \\ \vert {B}_{v} \vert - 1 / 2 & Else if v ∈ N or a junction \\ \vert {B}_{v} \vert & Otherwise .\end{matrix} \qquad ( 1 )$$

Let L be a list of all nodes sorted in non-increasing order according to their n_{ν} values. It may be said that node ν has a complete ordered relationship if in any feasible permutation of L it appears after all its ancestor, and before all its descendent, nodes in the tree T^{N} rooted by r.

In addition to Properties A-D, the present inventors formulated and discovered the following related Lemmas and Corollaries (whose proofs again have been developed, but not included herein for the same reasons stated before).

Lemma 1: Every node in N and every junction node has a complete ordered relationship.

Lemma 2: Consider two transit nodes u,vεV^{N}−N such that Bᵤ=B_{ν}, then every node x in the path between node u and ν is also a transit node with Bₓ=B_{ν}.

Corollary 1: Consider a transit node vεV^{N} and let C⊂V^{N} be the set of all transit nodes such that for every uεC, Bᵤ=B_{ν}. Then, all the nodes of C are included in a successive segment in the tree T^{N}.

### EXAMPLE 4

Consider a connecting tree spanned by the subnet N₁ and let node a be its root. Then, the sets B_{ν1},=B_{ν2}=B_{ν3}={b,c,d,e,f}. However, the n_{ν} values are not the same, because n_{ν1}=n_{ν2}=5 while n_{ν3}=4.5. Thus, a possible order of the nodes is L={a,ν₁,ν₂,ν₃,ν₅,e,f,c,d,c,d,b}.

Armed with the above Properties, Lemmas and Corollaries, a description of STC techniques provided by the present invention is now presented.

In one embodiment of the present invention, an NMS is operable to execute an STC method to compute a skeleton-tree H(Y,A) that represents the available topological information of a connecting tree T^{N}. This is an iterative process that adds a new labeled node vεV^{N} to the skeleton-tree H in each iteration, until all the labeled nodes are represented in H. As an input, the process receives the sets N and V^{N}, the root node rεN, and AFT information, i.e., F_{v,k}^{N} for each vεV^{N}.

In addition, in further embodiments of the present invention, an STC method executed by an NMS maintains a directed graph H(Y,A) that denotes the skeleton tree calculated so far. Every vertex yεY maintains a set C_{y}⊃V^{N} of the nodes that it represents and a parameter n_{y} that denotes the n_{ν} value of these nodes. (All the nodes νεC_{y} have the same n_{ν} value.) The arcs represent the known links in the considered tree. During a calculation, some of the arcs have an unknown” end-point (i.e., an end-point that has not been detected yet). These arcs are called frontier arcs. They are stored in a set, denoted by Z, until both end-points are detected. For every arc aεA an STC method (method and algorithm are used interchangeably throughout the discussion above and below) keeps a set Bₐ of all descendent nodes in N.

Again, the reader is encouraged to refer to FIG. 3 which depicts exemplary steps in an STC method used to generate skeleton trees according to an embodiment of the present invention.

Backtracking somewhat, initially an STC method of the present invention may perform the following steps: (a) for each node νεV^{N} a root-port, ν(r), is found that leads to r; (b) a set Bᵥ=∪_{kεD}_{v-{v(r)}}F_{v,k}^{N} is calculated; and (c) ν is added to B_{ν} if νεN. Further, an STC method of the present invention (as executed by an NMS or the like) may be operable to determine the value, n_{ν}, of node v as defined in Equation 1 above. As indicated above, a list L of the nodes V^{N}−{r} sorted in non-increasing order according to their n_{ν} values may be completed. After that, the skeleton tree H(Y,A) with a single vertex y that represents the root r is initialized. The latter is associated with a set C_{y}={r} and a value n_{y}=|N|+½. The exemplary method originates a set Z with |Dᵣ^{N}| arcs that denotes the incident links of node r that are included in T^{N}. Each arc aεZ is associated with a set Bₐ=F_{r,k}^{N} for one of the port kεDᵣ^{N}. An example of the initialization stage is presented in FIG. 3(a), while in FIG. 3(b) a node νₗ is added to H.

In a further embodiment of the present invention, after an initialization stage, the first node from L is iteratively removed, denoted by ν, and a skeleton-tree H(Y,A) is modified accordingly, as long as L is not empty. At each iteration, an arc aεZ with Bₐ⊃Bᵥ and yεY as its end-point (vertex) in H is sought. Two basic cases are distinguished.

If n_{y}=n_{ν} then from Lemmas 1 and 2, it follows that a node ν is a part of a segment represented by vertex y. Node ν is then added to C_{y} and a new node is selected from L, as presented in FIG. 3(c). Otherwise, if n_{y}≠nᵥ, this implies that a new vertex y′ should be added to H. The vertex y′ is then associated with a set C_{y′}={v} and a value n_{y},=nᵥ. For every leaf-port kεDᵥ^{N}−{v(r)} an outgoing frontier arc a′ for vertex y′ with B_{a′}=F_{v,k}^{N} is created and added to Z. Now, if Bₐ=B_{ν} then the arc a is connected to the vertex y′ and a is removed from the set Z, as shown in FIG. 3(d). Otherwise, it follows that Bₐ⊃Bᵥ and, consequently, it is concluded that the parent of ν in T^{N} is an unlabeled node.

Now, consider the next two cases. If a vertex y represents a labeled node, i.e., C_{y}≠∅, then a new vertex x may be created and inserted between the vertices y and y′. Because x represents an unlabeled node, it is associated with a set Cₓ=∩ and a value nₓ=|Bₐ|−½ (according to Equation 1). Vertex x is attached to two new arcs a₁, a₂ with Bₐ₁=B_{ν} and Bₐ₂=Bᵥ−Bᵥ. In a further embodiment of the present invention, a vertex x may be connected to an arc a that is incident to a vertex y and then attaches a vertex y′ to the arc a₁ of x. The arc a is removed from Z and the arc a₂ is inserted, as illustrated in FIG. 3(e).

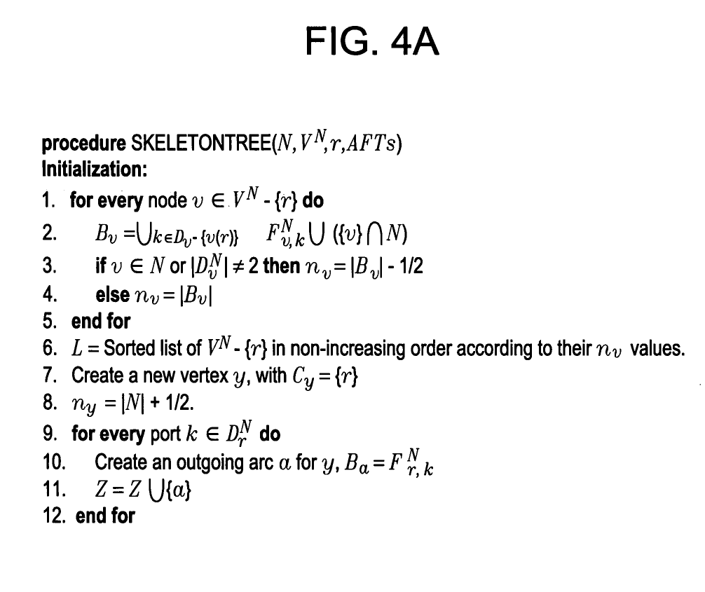

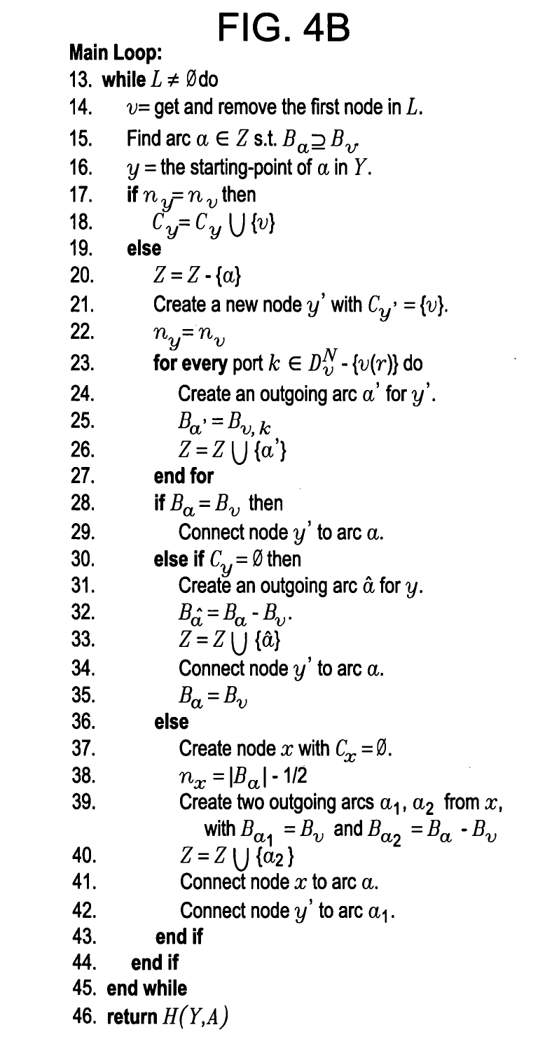

A second case results when y represents an unlabeled node, i.e., C_{y}≠∅. Because Bₐ⊃Bᵥ as stated above, node y represents the parent of node ν in T^{N} and another node (at least one) that has not been discovered yet. In a further embodiment of the present invention, an STC algorithm may create an additional arc â that is connected to vertex y with B_{â=B}ₐ−Bᵥ and adds it to Z. In addition, it connects vertex y′ to the arc a (with Bₐ=Bᵥ) and removes a from Z. An example of such case is presented in FIG. 3(f). At the end of the iteration, another node ν is selected from L. In our description we omit port-id information but this can easily be incorporated into our algorithm. A summary of exemplary steps that may be used in an STC method (e.g., program) of the present invention is given in FIG. 4.

Theorem 2: Consider a set N⊂V, its corresponding connecting-tree T^{N}(V^{N}, E^{N}) and any given root node rεN. Then, an STC method in accordance with the present invention computes a skeleton-tree H(Y, A) of T^{N}, where every node vεN or a junction node in T^{N} are represented by anchor vertices in Y.

Similar to above, the proof of Theorem 2 has been developed but not included herein.

The STC method just discussed requires complete AFTs of the set N for every node in V^{N}. However, complete AFTs may only be obtained when a message is sent between every pair of nodes in N. In practice, this may be very hard to accomplish. This requirement, however, can be replaced with a simpler one. The present inventors discovered that for every node vεV^{N} its set B_{ν} comprises only nodes of the subtree routed by ν. Accordingly, in accordance with an alternative embodiment of the present invention, Property 1's complete AFT requirement may be relaxed (i.e., information for each node is not required).
Property 3: Consider the connecting tree T^{N}(V^{N},E^{N}) of a given set N and a root node r. For every node vεV^{N}, an alternative STC method requires the AFT F_{ν,ν(r)} of its root-port to include r and the AFTs of all the its leaf-ports, kεDᵥ^{r}−{v(r)}, to be complete for the set N.

Because the AFT F_{ν,ν(r)} of the root-port is not required to be complete for the set N, a relaxed requirement may be achieved by sending probe messages from a single point in the network.

Though not repeatedly stated above, each of the steps in an STC method may be carried out in an NMS or the like.

In yet a further embodiment of the present invention, an NMS may be operable to augment skeleton trees AFTs of nodes in V^{N} with additional reachability information. Though is was stated beforehand that a skeleton tree can be calculated without having complete AFTs for the set N, however, the following augmentation is essential for merging skeleton trees. Let X⊂V^{N} be the set of anchor nodes in the tree T^{N}. This augmentation ensures that AFT information of nodes in TV are complete for the set X.

An NMS may calculate so-called “extended AFTs” in a recursive manner by performing a known post-order “tour” on a skeleton-tree, starting with a root r. In such a tour, each vertex yεY returns the set of anchor nodes X_{y}⊂V^{N} in its sub-tree to its parent vertex in H(Y,A). Consider a vertex yεY with children y₁,y₂, . . . ,y_{J}εY and let X_{y}_{ⱼ} be the set returned by vertex yⱼ to y. Clearly, if y is a leaf vertex in H(Y,A) then J=0 and no recursive calls are performed. After obtaining all the sets {X_{y}_{ⱼ}} from each child yⱼ of vertex y, the set X_{y} of vertex y may be calculated by taking the union of all the sets X_{y}, and the set C_{y} if y is an anchor vertex, i.e., X_{y}=(∪ⱼ₌₁^{J}X_{y}_{ⱼ})∪(X∩C_{y}). Then, the AFTs of every node vεC_{y} may be augmented as follows. For each root-port (ν,ν(r)) of every node vεC_{y}, the set X−X_{y}, is added to an AFT, i.e., F_{v,v(r)}=F_{v,v(r)}∪(X−X_{y}).

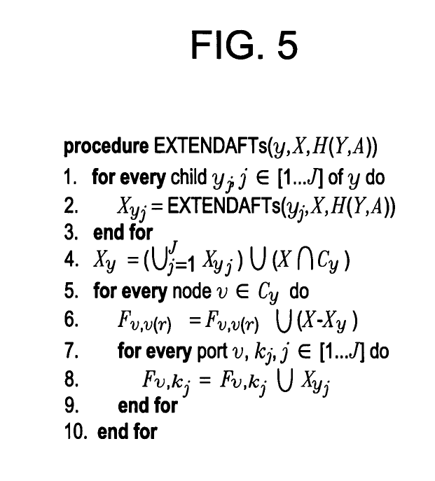

Now, if (ν, kⱼ) the leaf-port of node vεC_{y} that leads to the nodes represented by yⱼ, then, for each port (ν,kⱼ), the set X_{y}_{ⱼ}, i.e., F_{v,k}_{ⱼ}=F_{v,k}_{ⱼ}∪X_{y}_{ⱼ} is added to an AFT. Some steps used to extend information in an AFT according to an embodiment of the present invention are depicted in FIG. 5.

Theorem 3: Consider a connecting tree T^{N} (V^{N},E^{N}) and its corresponding skeleton tree H(Y,A). Let X be the set of anchors in both trees. Then, in yet a further embodiment of the present invention, extended AFTs for the set X for every node vεV^{N} may be calculated.

The above discussion has set forth novel methods and devices for discovering the topology of large multi-subnet LANs. It should be further noted here that the present inventors carried out corrective and complexity analyses. These analyses demonstrate the correctness of the techniques discussed above and confirmed the low overhead required. Again, the proofs, etc. related to these analyses have been omitted herein because they are not necessary for an appreciation of the present invention.

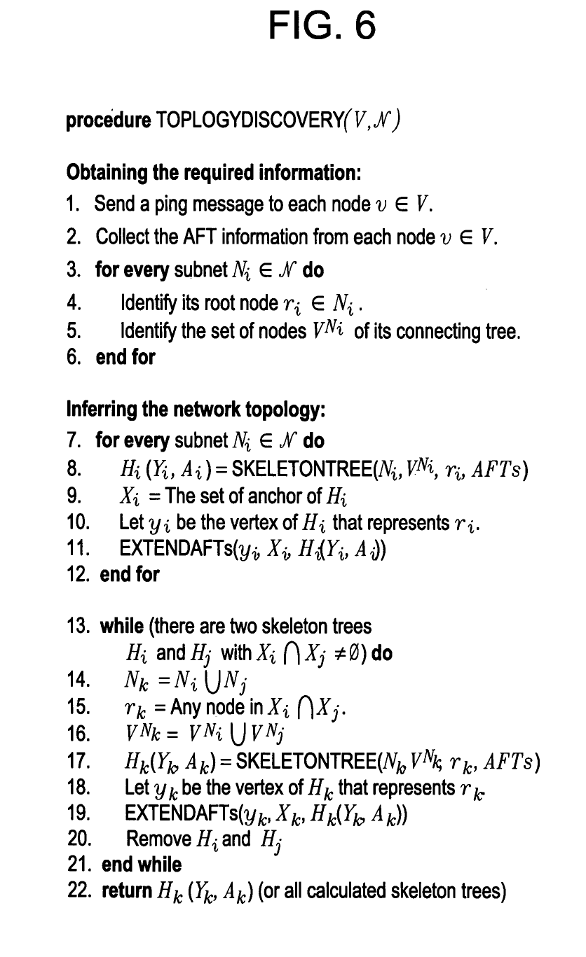

FIG. 6 depicts a summary of some of the steps in a topology discovery method discussed above.

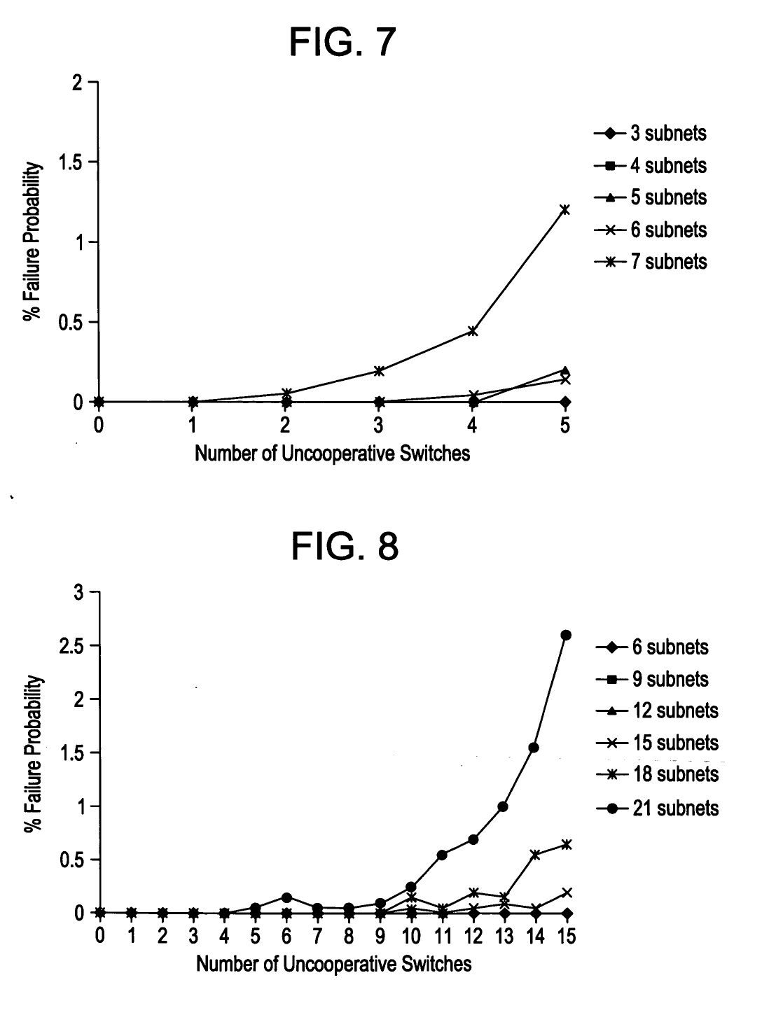

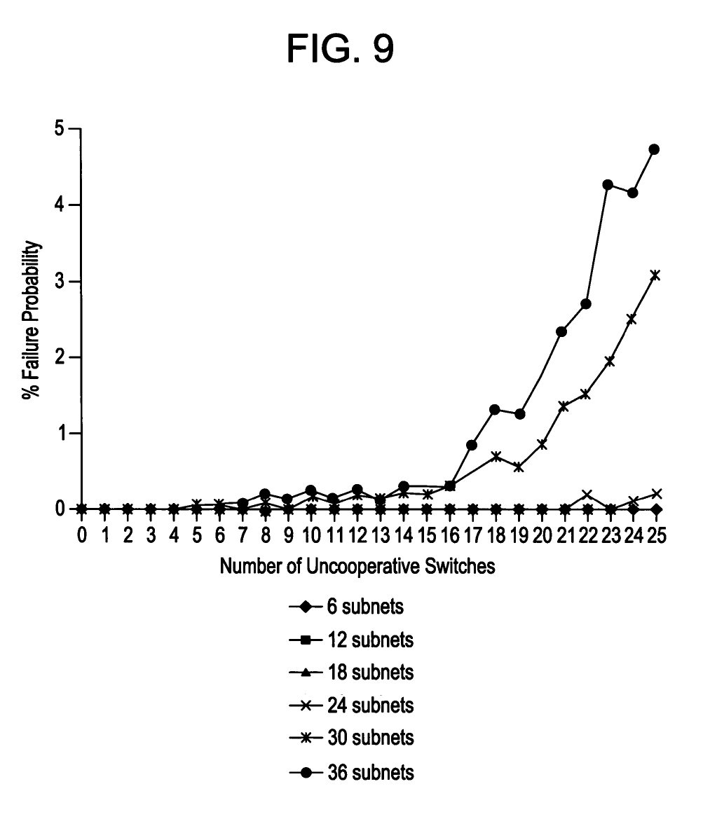

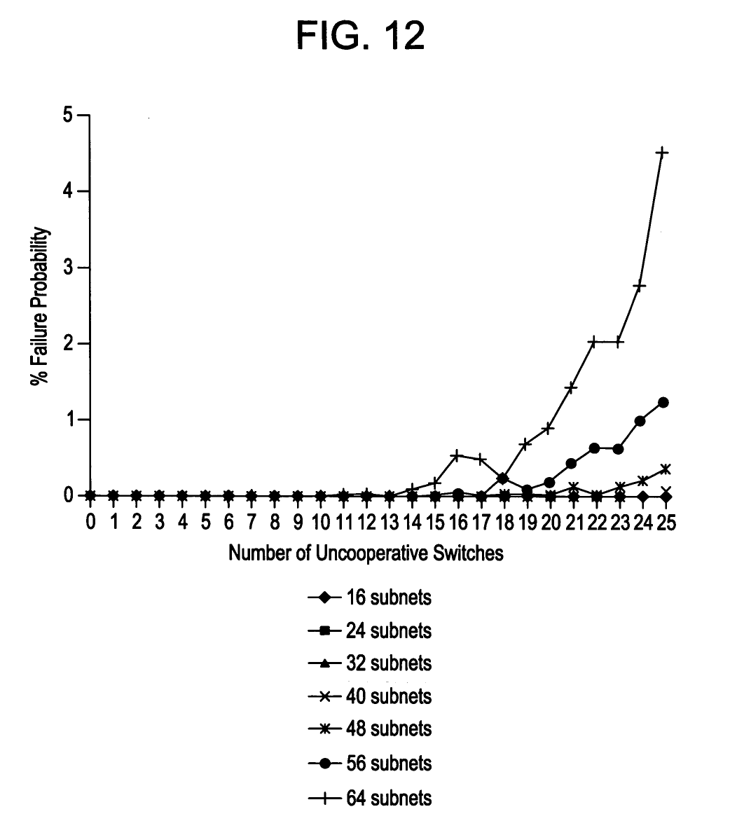

The present inventors carried out simulations, the results of which are set forth in FIGS. 7-12, to verify their discoveries. Each graph in FIGS. 7-12 represents a failure probability (in percentages) for an exemplary method of the present invention (i.e., a method's ability to infer the network topology as the number of subnets and uncooperative switches increases). Each point on a graph results from topology discovery attempts of 2000 random instances with the same characteristics (number of switches, hubs, hosts, subnets and uncooperative switches). For the sake of clarity, lines are added between points to show trends that result from changing the fraction of uncooperative switches in a simulated network, when the number of subnets is fixed.

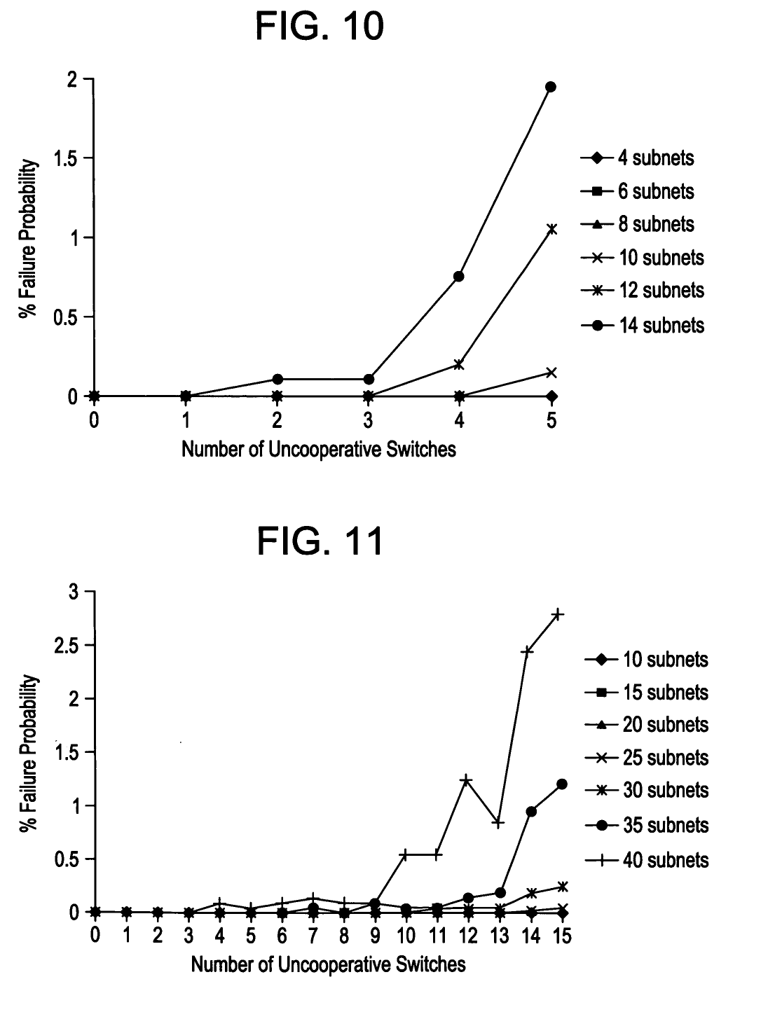

FIGS. 7-9 involve networks that comprise only 8-port switches and 8-port hubs. Each instance contains the same number of switches and hubs, and the number of host is 10 times the number of switches. Thus, on average 5 hosts are associated with each switch and hub. Similarly, FIGS. 10-12 involve networks that comprise only 24-port switches and 8-port hubs. Also, each instance contains the same number of switches and hubs. However, the number of hosts is 20 times the number of switches, and network instances were designed such that, on average, 15 hosts are associated with each switch and only 5 hosts are attached to each hub. In these simulations, the affect of different subnet sizes, starting with networks with a few large subnets and ending with subnets containing 15 or less hosts on average were considered. The effect of increasing the number of uncooperative switches from zero up to half of the switches' number was also taken into consideration.

These simulations indicate that the methods and devices of the present invention are capable of discovering the topology of subnets when the explored networks had a small number of uncooperative switches, i.e., approximately 100% probability of successfully discovering a topology. This by itself is impressive because in all of the evaluated instances half of the switching elements were dumb-hubs that do not provide AFT information. Moreover, these simulations also revealed that the probability of discovering a topology was almost always above 99.75% when the average number of hosts in a subnet equaled 20 or more.

This high probability of discovering a topology was also maintained when the number of uncooperative switches was increased to 50%. Recall that in these cases, 75% of a network's switching elements are uncooperative and only 25% provide AFT information.

These simulations also show that in extreme cases, where the average subnet size is 15 hosts or less and only 25% of a network's switching elements (switches and dumb-hubs) are cooperative, the probability of successfully discovering a topology is above 95%. These remarkable results indicate that even with very limited AFT information the probability of successfully discovering a topology is still very high.

In the discussion above it has been indicated that an NMS comprising one or more programmed microprocessors may be operable to carry out the methods, features and functions of the present invention.

In an alternative embodiment of the present invention, a topology discovery tool may be used to carry out the methods, features and functions of the present invention. Such a tool may comprise a combination of hardware, software, firmware, or some combination of the three.

In addition, the topology of virtual LANs may also be discovered by applying the methods of the present invention.

It should be understood that the discussion above only provides a few examples of the present invention, the true scope of which is covered by the claims which follow.

We claim:

1. A method for determining the topology of a multi-subnet, heterogeneous network comprising the steps of:
forming a preliminary topology based on address forwarding table (AFT) information obtained from one or more network elements (NEs) through SNMP queries; and
identifying one or more NEs that do not respond to SNMP queries and NEs adjacent to the identified NEs,
wherein the identified NEs are used to form a final topology.

2. The method as in claim 1 further comprising the steps of:
merging the identified NEs and associated edge connections from subnets that share an NE in common to form the final topology.

3. A method for determining the topology of a multi-subnet heterogeneous network comprising the steps of:
determining one or more connecting trees representing nodes in a subnet using address forwarding table (AFT) information;
forming skeleton-trees representing the connecting trees;
iteratively merging one or more pairs of skeleton trees, each tree associated with a common anchor node, to obtain a complete topology.

4. The method as in claim 3 wherein the AFT information is not complete AFT information for every node in the network.

5. The method as in claim 3 further comprising the step of obtaining the AFT information from backward learning operations on active ports.

6. The method as in claim 5 further comprising the steps of obtaining MAC addresses from each active port, wherein each MAC address represents the address of a source of packets.

7. The method as in claim 3 further comprising the steps of:
populating one or more AFTs using a common router; and
collecting AFT information using SNMP queries.

8. The method as in claim 3 further comprising the step of augmenting an AFT with an anchor node.

9. The method of claim 3 further comprising the step of compiling a list of ordered nodes according to their associated |Bᵥ| values,
where Bᵥ indicates a number of network elements in a subnet included in a sub-tree rooted by node ν.

10. The method as in claim 9 further comprising the step of utilizing the list to determine a skeleton tree for each subnet.

11. The method as in claim 9 further comprising the step of utilizing the list to merge pairs of skeleton trees.

12. The method as in claim 3 wherein the network comprises a virtual local area network.

13. A device for determining the topology of a multi-subnet, heterogeneous network operable to:
form a preliminary topology based on address forwarding table (AFT) information obtained from one or more network elements (NEs) through SNMP queries; and
identify one or more NEs that do not respond to SNMP queries and NEs adjacent to the identified NEs,
wherein the identified NEs are used to form a final topology.

14. The device as in claim 13 further operable to:
merge the identified NEs and associated edge connections from subnets that share an NE in common to form the final topology.

15. A device for determining the topology of a multi-subnet heterogeneous network operable to:
determine one or more connecting trees representing nodes in a subnet using address forwarding table (AFT) information;
form skeleton-trees representing the connecting trees; and
iteratively merge one or more pairs of skeleton trees, each tree associated with a common anchor node, to obtain a complete topology.

16. The device as in claim 15 wherein the AFT information is not complete AFT information for every node in the network.

17. The device as in claim 15 further operable to obtain the AFT information from backward learning operations on active ports.

18. The device as in claim 17 further operable to obtain MAC addresses from each active port, wherein each MAC address represents the address of a source of packets.

19. The device as in claim 15 further operable to:
populate one or more AFTs using a common router; and
collect AFT information using SNMP queries.

20. The device as in claim 15 further operable to augment an AFT with an anchor node.

21. The device of claim 15 further operable to compile a list of ordered nodes according to their associated |Bᵥ| values,
where Bᵥ indicates a number of network elements in a subnet included in a sub-tree rooted by node ν.

22. The device as in claim 21 further operable to utilize the list to determine a skeleton tree for each subnet.

23. The device as in claim 21 further operable to utilize the list to merge pairs of skeleton trees.

24. The device as in claim 23 wherein the device comprises a controller used in a network management system.

25. The device as in claim 23 wherein the device comprises a topology discovery tool.

26. The device as in claim 15 wherein the network comprises a virtual local area network.
